(19) United States
(12) Patent Application Publication
(10) Pub. No.: US 2023/0308824 A1
(43) Pub. Date: Sep. 28, 2023

(54) DYNAMIC MANAGEMENT OF A SOUND FIELD

(71) Applicant: International Business Machines Corporation, Armonk, NY (US)

(72) Inventors: Shailendra Moyal, Pune (IN); Shilpa Bhagwatprasad Mittal, Pune (IN); Akash U. Dhoot, Pune (IN); Sarbajit K. Rakshit, Kolkata (IN)

(21) Appl. No.: 17/656,230

(22) Filed: Mar. 24, 2022

(51) Int. Cl. H04S 7/00

(52) U.S. Cl. CPC H04S 7/302

(57) ABSTRACT

A processor may receive sound data associated with a bounded environment. The sound data may be associated the sound data is associated with a sound field. The processor may analyze the sound data associated with the sound field to identify one or more external sound sources and one or more internal sound sources. The processor may generate one or more simulations of the sound field based, at least in part, on a user preference set. The processor may modify a sound field within the bounded environment. The modified sound field may be based, at least in part, on the one or more simulations of the sound field and the user preference set.

### BACKGROUND

Aspects of the present disclosure relate generally to the field of artificial intelligence, and more particularly to manipulating sound waves.

Noise pollution may include any noise from an external source that negatively impacts an area the noise should not be. For example, in a school classroom setting traffic sounds associated with vehicles directly outside the school may travel into the school and become audible to the students and teacher. The traffic sounds may result in a decrease in student focus and act as a disruption to the teacher attempting to present a lesson to the students.

### SUMMARY

Embodiments of the present disclosure include a method, computer program product, and system for dynamically managing a sound field. A processor may receive sound data associated with a bounded environment. The sound data may be associated with a sound field. The processor may analyze the sound data associated with the sound field to identify one or more external sound sources and one or more internal sound sources. The processor may generate one or more simulations of the sound field based, at least in part, on a user preference set. The processor may modify a sound field within the bounded environment. The modified sound field may be based, at least in part, on the one or more simulations of the sound field and the user preference set.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example sound management system, in accordance with aspects of the present disclosure.

FIG. 2 illustrates a flowchart of an example method for managing sound in a bounded environment, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of artificial intelligence, and more particularly to managing sound in particular environments. While the present disclosure is not necessarily limited to such applications, various aspects of the disclosure may be appreciated through a discussion of various examples using this context.

Noise pollution, particularly in areas that are heavily populated, can negatively impact a person's enjoyment of a particular event, particularly in scenarios where the user is attempting to experience other forms of sound, such as a music concert, comedy show, and the like. In these situations, sound from sources in the environment surrounding concert hall, such as honking car horns, can leak into the concert hall and be audible over the music concert. This noise pollution may negatively impact the user's over all satisfaction of the music concert. As there is a desire to identify how sound waves, such as those associated with noise pollution, and eliminate or mitigate their impact on users in a particular environments (e.g., bounded environments).

Before turning to the FIGS. it is noted that the benefits/novelties and intricacies of the proposed solution are that:

A sound management system may dynamically reposition control sound by performing sound repositioning and sound cancelling using microphone modules, and speaker modules (e.g., smart devices) that may be positioned in the bounded environment. the sound management system may use the aforementioned modules and sound modulation techniques to control sound. For example, the sound management system may increase/decrease volume of sound in a particular portion of the bounded environment.

The sound management system may evaluate the level of noise or undesirable sound (e.g., external sound) that may be associated with the environment surrounding the bounded environment. Based on the level of noise in the environment surrounding the bounded environment, the sound management system may be configured to analyze sound data (e.g., external and internal sound) to determine if a noise reduction module may be required and, if a noise reduction module is required, where the noise reduction module should be place in the environment. For example, based on the level of noise, a noise reduction module may be positioned to cancel noise (e.g., external sound) in a particular direction. In some embodiments, the noise reduction module may be dynamically moved within or around the bounded environment (e.g., dynamically positioned) to cancel noise as needed.

The sound management system may analyze sound data to identify one or more contextual situations. Once a contextual situation is identified, the sound management system may amplify or reduce the noise reduction in the environment surrounding the bounded environment. In such environments, the sound management system may use this analysis to determine the necessary alignment or layout of noise reduction modules that may be used to reduce the impact of external sound on the bounded environment.

The sound management system may analyze the sound data to determine if there is sensitive information in the bounded environment. If the sound management system determines there is sensitive information in the bounded environment, the sound management system may determine the sensitivity level of the sensitive information. In these embodiments, the sound management system may deploy one or more noise reduction modules to and/or around the bounded environment to reduce the sound waves associated with the sensitive information from transmitting outside the bounded environment.

The sound management system may analyze the sound data to identify the layout of microphones installed in the bounded environment. The sound management system may be configured with a graphical user interface that may allow a user to view various aspects of the sound management system. In some embodiments, the sound management system provide a user with a graphical user interface that allows the user to manipulate and/or define the sound fields in the bounded environment. In these embodiments, the sound management system may configure and dynamically change the position of different modules (e.g., microphone modules and noise cancellation modules) using smart devices to reflect the changes the user makes to the bounded environment via the graphical user interface. In some embodiments, the sound management system may provide visualization of the bounded environment to an administrator. In such embodiments, the administrator may graphically control or change the patterns of the sound field within the bounded environment. In these embodiments, the sound management system may dynamically change the positions of the sound management modules (e.g., smart devices) to reflect the administrator's changes to the sound field within the bounded environment.

The sound management system may use the received/collected sound data over time to generate a historical corpus. In embodiments, the sound management system may use the historical corpus to predict the required number of smart devices (e.g., noise reduction modules) and/or how the smart devices may be positioned or aligned around and/or within the bounded environment for a particular event (e.g., lecture, concert, etc.) to control to sound wave pattern within the bounded environment and reduce possible noise pollution (e.g., external sound) that may result from sources that are external to the bounded environment (e.g., car horn).

In embodiments where events are held within the bounded environment, the sound management system may be configured to provide one or more users the ability to control the patterns of the sound field around their particular position within the bounded environment. In these embodiments, the sound management system may dynamically control the audio management modules within and surrounding the bounded environment based on the one or more user's defined sound field patterns. In one example embodiment where a user purchases a ticket for a particular seat when attending a concert within the bounded environment, the user, prior to and/or during the concert, may control different aspects of the sound field directly in the portion of the bounded environment where the seat is located. In such embodiments, prior to the actual event (e.g., concert) the sound management system may be configured to provide a user may with a simulation of how the sound in a particular portion of the bounded environment may be, based on the user's sound pattern selections. In these embodiments, the sound management system may enable the user to feel the effects of the sound field to ensure the user has sufficiently adjusted the sound field as desired.

The sound management system may also be configured by a user to consider a user's hearing aids. For example, a user may control the sound field to ensure the user has a better experience that takes into consideration the user's health considerations.

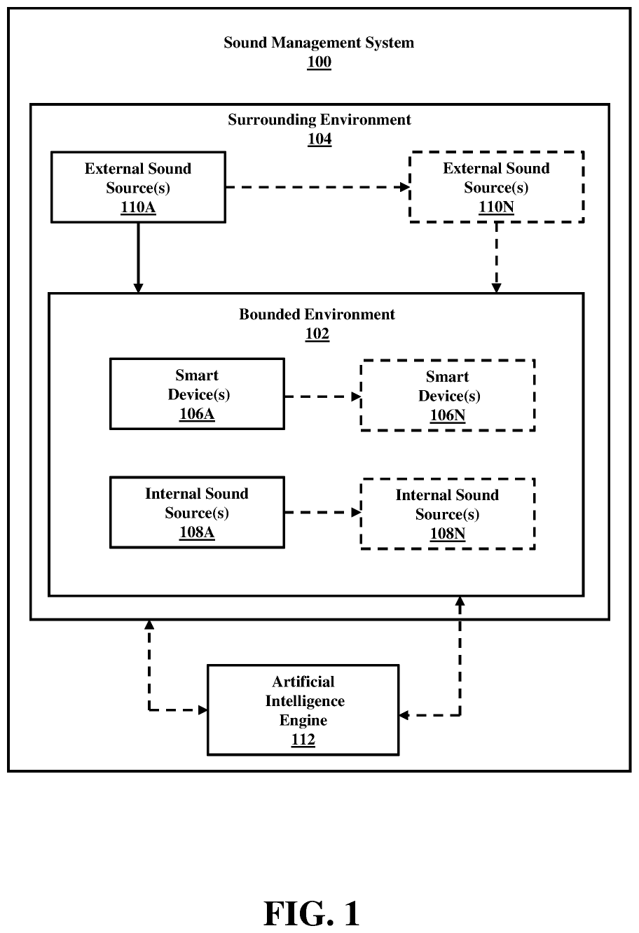

Referring now to FIG. 1, illustrated is a block diagram of an example sound management system 100 for dynamically managing and/or controlling a sound field within a bounded environment, in accordance with aspects of the present disclosure. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims.

In embodiments, sound management system 100 may include bounded environment 102 and surrounding environment 104. Bounded environment 102 may be any area where sound waves are generated for a particular purpose for one or more users. While in some embodiments, bounded environment 102 may be bounded or constrained by physical structures (e.g., a fence or walls), in other embodiments bounded environment 102 may be bounded or constrained by a digital fence/geofence or boundary. Bounded environment 102 may include, but is not limited to areas such as, an open area (e.g., open park area), a building (e.g., concert hall, movie theater, etc.), or any other partial structure (e.g., amphitheater). In some embodiments, bounded environment 102 may include a combination of both digital and physical constraints.

Surrounding environment 104 may include any area surrounding bounded environment 102 that is outside the constrains of bounded environment 102. In embodiments, surrounding environment 104 may include one or more external sound sources 110A-110N. One or more external sound sources 110A-110N may refer to any device or source that may generate undesirable soundwaves that may impact or pollute the desired sound associated with bounded environment 102.

In embodiments, bounded environment 102 may include one or more smart devices 106A-N and/or one or more internal sound sources 108A-N. One or more internal sound sources 108A-N may be configured to generate sound waves within bounded environment 102 a user desires to hear and experience. One or more internal sound sources 108A may include, but are not limited to, human orators (e.g., people who are talking or singing within bounded environment 102), instruments (e.g., instruments associated with an orchestra playing within bounded environment 102), as well as microphones, speakers and other devices used to transmit the desired soundwaves to one or more users positioned throughout bounded environment 102. In some embodiments, a smart device 106A may be configured as part devices associated with the internal sound source 108A. For example, one or more smart devices 106A-N may be configured in one or speakers or amplifiers throughout bounded environment 102. While one or more smart devices 106A-N may be configured within bounded environment 102, some one or more smart devices 106A-N may also be positioned in surrounding environment 104 and/or proximate to bounded environment 102.

In these embodiments, one or more smart devices 106A-106N may include Internet of Things (IoT) devices, sensors, and sound modules (e.g., an array of microphones configured to capture the noise pollution generated by a car honking (e.g., external devices 110A-N) in the surrounding environment 104). In embodiments, one or more smart devices 106A-N may be configured to perform multiple functions. These functions may include, but are not limited to collecting/receiving sound data associated with bounded environment 102 and the surrounding environment 104 and perform sound modulation (e.g., microphone modules, and speaker modules) that may be used to control or manipulate the sound field (e.g., sound waves associated with the desired sound and preventing sound pollution from sound waves originating from the surrounding environment) associated with bounded environment 102. Sound data may include any data/information associated with the sound field of the bounded environment (e.g., desired soundwaves of the user). More particularly, sound data may include, but is not limited to data/information such as sound patterns (e.g., sound waves) generated by internal devices 108A-N, sound patterns (e.g., sound waves) external devices 110A-N, data/information generated as part of any analyses contemplated herein (e.g., via AI Engine 112), data/information associated with one or more users preference regarding how the user indicates how they want to experience the desired sound (e.g., heavy or low base), data/information associated with how the sound waves within the sound field are manipulated (e.g., data received in real-time from one or more smart devices 106A-N). In some embodiments, sound data may be collected over time and stored in a historical repository. Sound data stored in this historical repository may be used to perform various analyses as contemplated herein using AI engine 112.

In embodiments, the one or more smart devices 106A-N may be configured to have one or more sound modules such as microphone modules, and speaker modules that may be configured to generate constructive and deconstructive wave modulation. These sound modules may be used by sound management system 100 to modify and/or control the sound field of the bounded environment 102 to ensure the user can experience the desired sound (e.g., based on the user's indicated user preference). In some embodiments, these sound modules may be used to eliminate sound pollution from the surrounding environment 104 that may affect the desired sound produced within bounded environment 102. For example, the one or more smart devices 106A-N may be configured as modules including, but not limited to sound cancelling using microphone modules, and speaker modules. While in some embodiments, some of the one or more smart devices 106A-N may be fixed at a stationary location, in other embodiments, one or more smart devices 106A-N may be configured to be mobile. For example, in some embodiments, some of one or more smart devices 106A-N may have robotic structures (e.g., robotic arms, robotic flying structures, etc.) that may enable the one or more smart devices 106A-N to be move throughout bounded environment 102 and/or surrounding environment 104.

In embodiments, sound management system 100 may be configured to analyze sound data using AI engine 112. In embodiments, sound management system 100 may configured AI engine 112 to use AI and machine learning techniques to perform the various analyses contemplated herein. These analyses may be performed using sound data collected from the bounded environment 102 and surrounding environment 104 (e.g., real-time sound data and historical sound data). AI engine 112 may be configured to generate one or more simulation associated with the sound field of the bounded environment. AI Engine 112 may use the generated simulations to identify the source of the sound waves (e.g., sound waves from internal sound source devices 108A-N and external sound source devices 110A-N.) and distribution of sound waves within the sound field in bounded environment 102 and surrounding environment 104. Using these analyses, sound management system 100 may configure AI engine 112 to generate one or more simulations of the one or more sound fields.

In some embodiments, sound management system 100 may be configured to receive a user preference sets. In some embodiments, user preferences sets may be considered a form of sound data. A user preference set may be associated with a single user or a group of users. In some embodiments, the user preference set may include one or more sound attributes associated with how the user or users desire to interact with the one or more sound fields associated with bounded environment 102. Sound management system 100, using the generated simulations and user preference set (e.g., via AI engine 112), may be configured to generate one or more sound visualizations for a user. In some embodiments, a user may be an administrator. In some embodiments, sound management system 100 may be configured to receive a user preference set as the user is interacting with the generated visualization. When the user interacts with the generated visualization, the user preference set may be updated. As the user preference set are updated, sound management system 100 may configure the one or more smart device 106A-N to modify or manipulate the sound field (e.g., using constructive or deconstructive wave interference).

In some embodiments, the user preference set may be reflected in the one or more sound fields of the bounded environment 102 in real-time. For example, the user may use an application on their mobile device and indicate that they would like to experience more bass. In this example, one or more smart devices 106A-N may be configured to provide this user with additional base (e.g., desired sound field) while ensuring other users in the bounded environment are not affected and are able to interact with the sound field based on their own user preferences. In other embodiments, sound management system 100 may configured AI engine 112 to generate a visualization of the one or more sound fields store, based on the user's updated user preference set prior to the event. In such embodiments, sound management system 100 may be configured to provide a user a virtual reality (VR) and/or augmented reality (AR) (e.g., using AI engine 112) that will allow the user to experience the sound field of the bounded environment 102 without the user having to be physically located within bounded environment 102.

In such embodiments, sound management system 100 may be configured to receive feedback from the user as the user is interacting in the visualization (e.g., VR/AR version of the bounded environment 102 and the associated sound field). This feedback may be stored as a user preference set. When the user attends the scheduled event within the bounded environment 102, the user preference set will automatically be applied to the sound field associated with the user's position within bounded environment 102. As contemplated herein, one or more smart devices 106A-N may be configured to generate, modify, and/or control the sound field associated with bounded environment by performing different types of sound modulation and by using robotic features that allow sound management system 100 to move throughout bounded environment 102 to perform sound modulation where needed (e.g., based on the user preference set).

In embodiments, sound management system 100 may classify the visualizations and any number of the generated simulations to use in future analyses (e.g., future simulations and/or visualizations). Sound management system 100 may classify this data/information as sound data and store it in a historical repository for future analyses performed by AI engine 112. Often, as more data is received, AI engine 112 may generate more accurate simulations and, in some embodiments, more accurate control/modification of the sound field within the bounded environment.

In embodiments, AI engine 112 may be configured to analyze the sound data and sound data associated with the real-time sound field of the bounded environment 102. AI engine 112 may be configured how the one or more smart devices 106A-N configured as sound modules should be configured within bounded environment 102. For example, AI engine may analyze sound data and determine sound pollution from one or more external sound sources how the sound pollution affects the sound field of the bounded environment 102. In this example, to reduce or eliminate the sound pollution's impact on the sound field of the bounded environment 102, sound management system 100 may configure AI engine 112 to identify where different sound modules should be positioned either in the surrounding environment 104 or bounded environment 102 that will best ensure the sound pollution does not, at least significantly, impact the sound field of bounded environment 102.

In some embodiments, sound management system 100 may be use AI engine 112 to identify how many sound modules should be used to effectively mitigate the impact of external sound waves (e.g., form external sound sources 110A-N). In such embodiments, AI engine 112 may be configured to perform one or more simulations to identify the number and location of where each sound module should be positioned within bounded environment 102 and/or surrounding environment 104. AI engine 112 may base this determination on each sound module's ability to modify/control the sound waves within the sound field. Once sound management system 100 has determined the number and location each sound module should be positioned, sound management system 100 may be configured to direct each sound module (e.g., smart device), based on the sound module's robotic mobility, to the appropriate position within the bounded environment 102 and/or the surrounding environment 104. In some embodiments, sound management system 100, via AI engine 112 may be configured to position or reposition the sound module prior to the sound field actually being generated (e.g., based on simulations), or may be able to position or reposition the sound module in real-time while the sound field is generated. This positioning/repositioning may be associated with a change in the user's user preference set.

In some embodiments, the bounded environment 102 may be a concert hall or arena where different events may be held. In these embodiments, users may be able to purchase and reserve particular seats or portions of bounded environment 102 while the particular event is occurring (e.g., sound field is generated). In some embodiments, sound management system may be configured to allow the user to create or update their user preference set while the user is purchasing a ticket reserving their particular seat or portion within bounded environment 102. Sound management system 100 may then implement (e.g., via AI engine 112) and apply the user preference to the sound field when they are in their reserved portion of bounded environment 102.

Alternatively, in some embodiments, sound management system 100 may use AI engine 112 to generate one or more simulations using sound data and a user's user preference set. In such embodiments, when a user attempts to reserve particular seats or portions of bounded environment 102, sound management system 100 may be configured to recommend a portion or seat that will closely align with the user's user preference set.

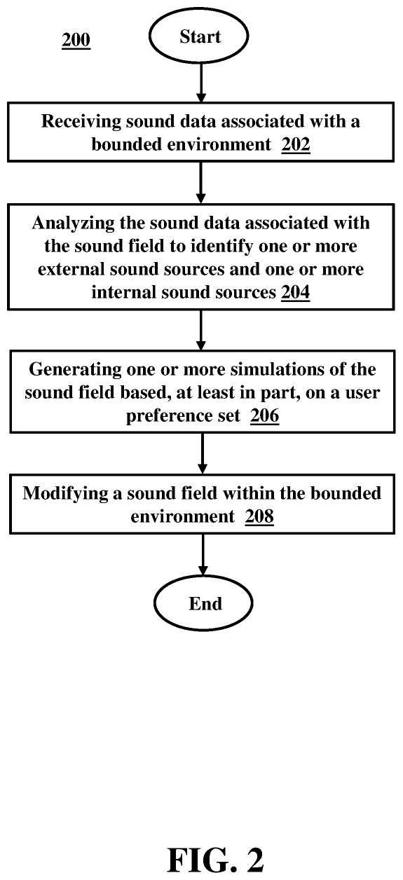

Referring now to FIG. 2, a flowchart illustrating an example method 200 for managing a sound field in a bounded environment, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202 where a processor may receive sound data associated with a bounded environment. In some embodiments, the sound data may be associated with an external sound set and an internal sound set. In some embodiments, the method 200 proceeds to operation 204.

At operation 204, a processor may analyze the sound data associated with one or more sound fields. In some embodiments, the method 200 proceeds to operation 206.

At operation 206, a processor may generate one or more simulations of the one or more sound fields based, at least in part, on a user preference set. In some embodiments, the method 200 proceeds to operation 208.

At operation 208, a processor may generate a modified sound field within the bounded environment. In some embodiments, the modified sound field may be based, at least in part, on the simulation of the sound field and the user preference set. In some embodiments, as depicted in FIG. 2, after operation 208, the method 200 may end.

In some embodiments, discussed below, there are one or more operations of the method 200 not depicted for the sake of brevity and which are discussed throughout this disclosure. Accordingly, in some embodiments, the processor may identify a particular portion of the bounded environment. In these embodiments, the processor may then modify the sound field. Modifying the sound field may include orienting a sound module. In embodiments where a processor orients the sound module, the processor may also modulate the sound field. This modulation may be based on the one or more simulations contemplated herein.

In some embodiments, the processor may generate one or more visualizations of the sound field for a user. In some embodiments the visualizations may be based, at least in part, on the one or more simulations. The processor may then provide the one or more visualizations to the user.

In embodiments where the processor generates one or more visualizations, the processor may analyze one or more interactions of the user with the one or more visualizations. Using these analyses, the processor may identify one or more preferences of the user based on the one or more interactions. Once identified, the processor may update the user preference set with the one or more preferences.

In some embodiments, the processor may analyze the user preference set. This analysis may be based, at least in part, on the one or more visualizations. The processor may then generate one or more user recommendations associated with an event. The event may be associated with the bounded environment. The one or more recommendations may be associated with a particular portion of the bounded environment and the user preference set. In some embodiments, the processor may automatically select a particular portion of the bounded environment for the user to occupy during an event. The particular portion may be selected based on the user preference set.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

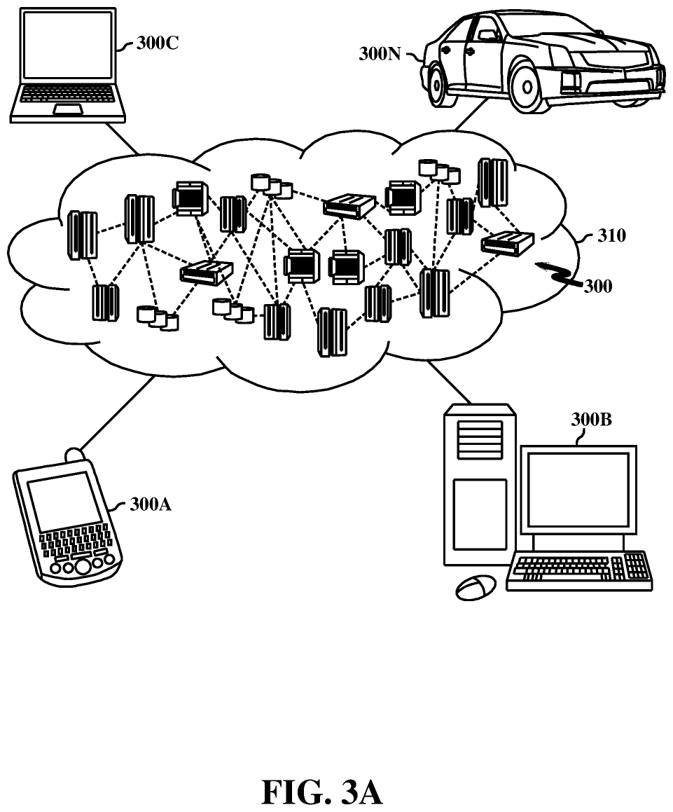

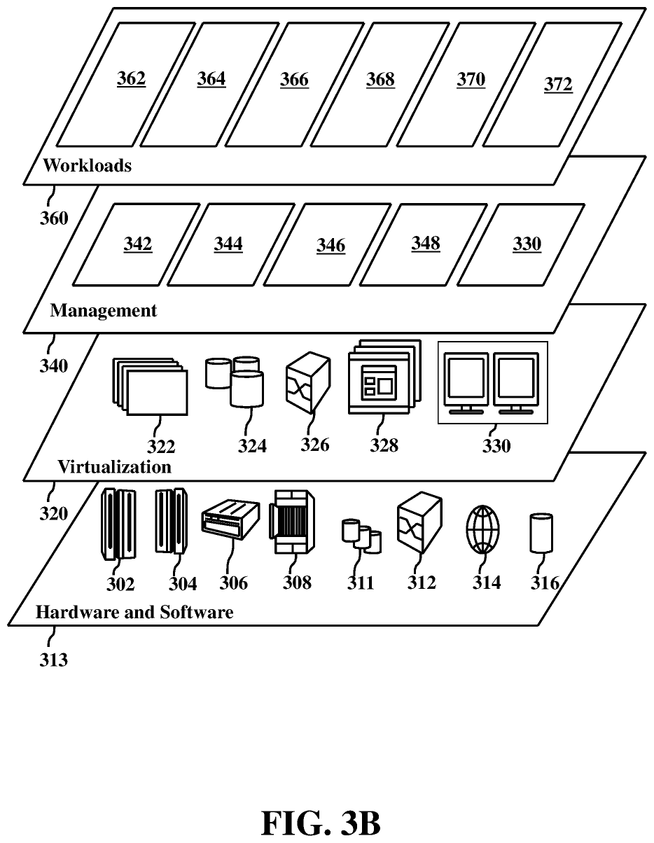

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and sound field control 372.

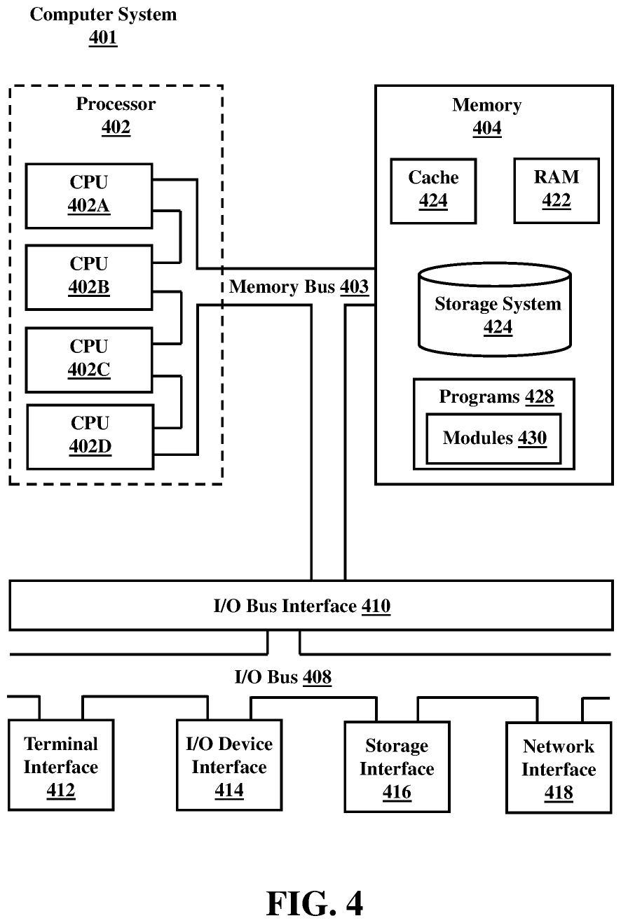

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, sound data associated with a bounded environment, wherein the sound data is associated with a sound field;
analyzing the sound data associated with the sound field to identify one or more external sound sources and one or more internal sound sources;
simulating the sound field based, at least in part, on a user preference set; and
modifying a sound field within the bounded environment, wherein the modified sound field is based, at least in part, on the one or more simulations of the sound field and the user preference set.

2. The method of claim 1, further comprising:
identifying a particular portion of the bounded environment; and
modifying the sound field, wherein modifying the sound field includes orienting a sound module.

3. The method of claim 2, wherein orienting the sound module further includes modulating the sound field, based on the one or more simulations.

4. The method of claim 1, further comprising:
generating one or more visualizations of the sound field for a user, wherein the visualizations are based, at least in part, on the one or more simulations; and
providing the one or more visualizations to the user.

5. The method of claim 4, wherein generating the one or more visualizations further includes:
analyzing one or more interactions of the user with the one or more visualizations;
identifying one or more preferences of the user based on the one or more interactions; and
updating the user preference set with the one or more preferences.

6. The method of claim 5, further including:
analyzing the user preference set, based at least in part on the one or more visualizations; and
generating one or more user recommendations associated with an event associated with the bounded environment, wherein the one or more recommendations are associated with a particular portion of the bounded environment and the user preference set.

7. The method of claim 4, further including:
automatically selecting a particular portion of the bounded environment for the user to occupy during an event, wherein the particular portion is selected based on the user preference set.

8. A system, the system comprising:
a memory; and
a processor in communication with the memory, the processor being configured to perform operations comprising:
receiving sound data associated with a bounded environment, wherein the sound data is associated with a sound field;
analyzing the sound data associated with the sound field to identify one or more external sound sources and one or more internal sound sources;
simulating the sound field based, at least in part, on a user preference set; and
modifying a sound field within the bounded environment, wherein the modified sound field is based, at least in part, on the one or more simulations of the sound field and the user preference set.

9. The system of claim 8, further comprising:
identifying a particular portion of the bounded environment; and
modifying the sound field, wherein modifying the sound field includes orienting a sound module.

10. The system of claim 9, wherein orienting the sound module further includes modulating the sound field, based on the one or more simulations.

11. The system of claim 8, further comprising:
generating one or more visualizations of the sound field for a user, wherein the visualizations are based, at least in part, on the one or more simulations; and
providing the one or more visualizations to the user.

12. The system of claim 11, wherein generating the one or more visualizations further includes:
analyzing one or more interactions of the user with the one or more visualizations;
identifying one or more preferences of the user based on the one or more interactions; and
updating the user preference set with the one or more preferences.

13. The system of claim 12, further including:
analyzing the user preference set, based at least in part on the one or more visualizations; and
generating one or more user recommendations associated with an event associated with the bounded environment, wherein the one or more recommendations are associated with a particular portion of the bounded environment and the user preference set.

14. The system of claim 11, further including:
automatically selecting a particular portion of the bounded environment for the user to occupy during an event, wherein the particular portion is selected based on the user preference set.

15. A computer program product comprising a computer readable storage medium having program instructions embodied therewith, the program instructions executable by a processor to cause the processor to perform operations, the operations comprising:
receiving sound data associated with a bounded environment, wherein the sound data is associated with a sound field;
analyzing the sound data associated with the sound field to identify one or more external sound sources and one or more internal sound sources;
simulating the sound field based, at least in part, on a user preference set; and
modifying a sound field within the bounded environment, wherein the modified sound field is based, at least in part, on the one or more simulations of the sound field and the user preference set.

16. The computer program product of claim 15, further comprising:
identifying a particular portion of the bounded environment; and
modifying the sound field, wherein modifying the sound field includes orienting a sound module.

17. The computer program product of claim 16, wherein orienting the sound module further includes modulating the sound field, based on the one or more simulations.

18. The computer program product of claim 15, further comprising:
generating one or more visualizations of the sound field for a user, wherein the visualizations are based, at least in part, on the one or more simulations; and
providing the one or more visualizations to the user.

19. The computer program product of claim 18, wherein generating the one or more visualizations further includes:
analyzing one or more interactions of the user with the one or more visualizations;
identifying one or more preferences of the user based on the one or more interactions; and
updating the user preference set with the one or more preferences.

20. The computer program product of claim 19, further including:
analyzing the user preference set, based at least in part on the one or more visualizations; and
generating one or more user recommendations associated with an event associated with the bounded environment, wherein the one or more recommendations are associated with a particular portion of the bounded environment and the user preference set.
